(19) United States
(12) Patent Application Publication
(10) Pub. No.: US 2018/0179987 A1
(43) Pub. Date: Jun. 28, 2018

(54) Variable compression ratio engine gasket

(71) Applicant: Edward Charles Mendler, Mill Valley, CA (US)

(72) Inventor: Edward Charles Mendler, Mill Valley, CA (US)

(21) Appl. No.: 15/732,723

(22) Filed: Dec. 20, 2017

Related U.S. Application Data
(60) Provisional application No. 62/498,373, filed on Dec. 22, 2016.

(51) Int. Cl. F02F 11/00; F02B 75/04; F16J 15/10

(52) U.S. Cl. CPC F02F 11/002; F02F 7/0085; F16J 15/104; F02B 75/041

(57) ABSTRACT

According to the present invention a closed cell compressible sponge is used to provide a seal between the cylinder head assembly and the crankcase assembly in variable compression ratio engines. The closed cell sponge is capable of accommodating large travel distances and can be fabricated out of durable rubber. The sponge gasket also does not flap, and is effective at isolating noise inside the crankcase.

This application relates to Provisional Application No. 62/498,373 having a filing date of Dec. 22, 2016.

The present invention was made during performance of work under United States Department of Energy contract number DE-EE0005981.

### BACKGROUND OF THE INVENTION

Variable compression ratio engines having a cylinder head assembly that is movable relative to the crankcase assembly require a sealing element between the crankcase and cylinder head in order to contain the engine oil. Saab Automobile Powertrain AB has developed a variable compression ratio engine of this kind, and shows a sealing bellows in FIG. 7 of Society of Automotive Engineers paper number 2002-01-0996 having a publication date of March 2002. Envera LLC has also developed a variable compression ratio engine of this kind, and shows a sealing curtain in FIG. 1 of PCT Patent Application US2016/000043 by Mendler published Dec. 8, 2016 under No. WO 2016/195756. These sealing elements may flap under oscillating crankcase gas pressure, leading to wear and failure of the seal. Crankcase noise is also not well contained within the crankcase. Accordingly, a durable low cost sealing element is needed that also has a low cost. Travel distance between the sealing surfaces is as large as 15 millimeters in some automotive or truck engines. Accordingly, the seal must also be capable of accommodating large travel distances.

### SUMMARY OF THE INVENTION

According to the present invention a closed cell compressible sponge is used to provide a seal between the cylinder head assembly and the crankcase assembly in variable compression ratio engines. The closed cell sponge is capable of accommodating large travel distances and can be fabricated out of durable rubber. The sponge gasket also does not flap, and is effective at isolating noise inside the crankcase.

### BRIEF DESCRIPTION OF THE FIGURES

FIG. 1 is intended to illustrate a sponge seal for a variable compression ratio engine according to the present invention.

FIG. 2 is similar to FIG. 1 but shows the variable compression ratio engine at a different compression ratio setting.

FIG. 3 is intended to illustrate a sponge seal having an articulated surface.

### DETAILED DESCRIPTION OF THE PREFERRED EMBODIMENTS

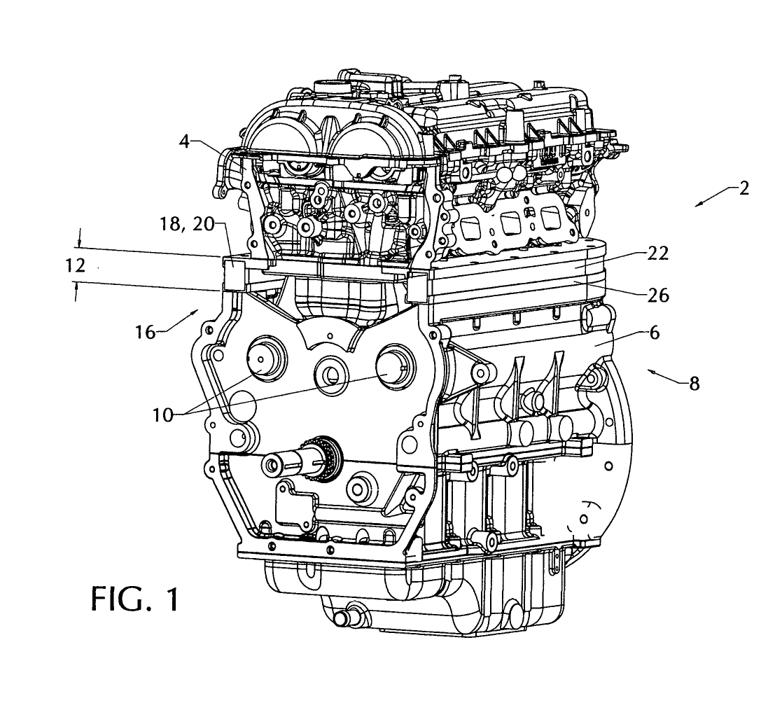

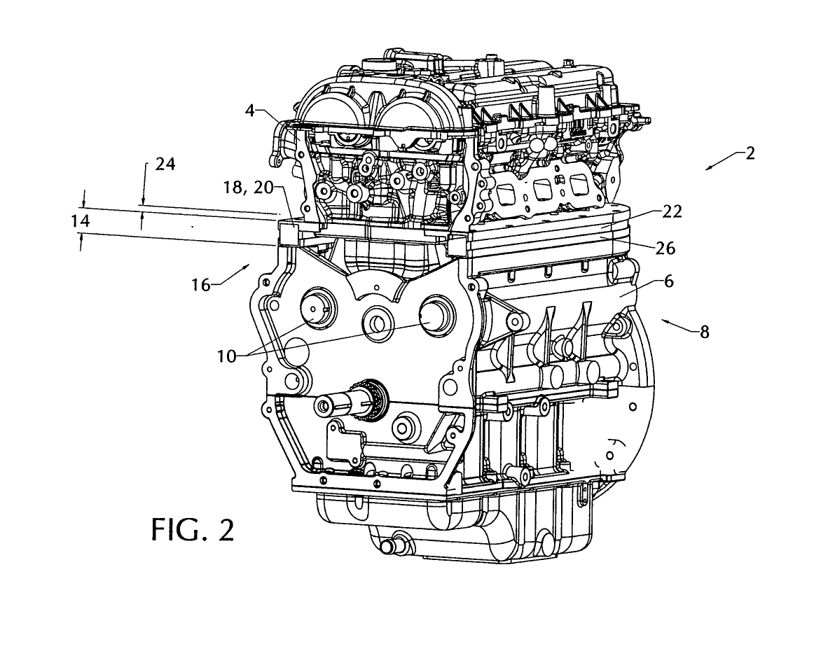

FIG. 1 is intended to illustrate a variable compression ratio engine 2 having a cylinder head assembly 4, a crankcase assembly 6 and a variable compression ratio 8. Compression ratio may be adjusted by different means according to the present invention. In the embodiment shown in FIG. 1 variable compression ratio engine 2 includes control shafts 10 having eccentric or offset journals. Referring now to FIGS. 1 and 2, rotation of control shafts 10 adjusts the spacing between cylinder head assembly 4 and crankcase assembly 6 for adjusting the compression ratio of the engine. FIG. 1 shows variable compression ratio engine 2 with a large spacing 12 between cylinder head assembly 4 and crankcase assembly 6 for providing a low compression ratio. FIG. 2 shows variable compression ratio engine 2 with a smaller spacing 14 between cylinder head assembly 4 and crankcase assembly 6 for providing a high compression ratio.

According to the preferred embodiment of the present invention, variable compression ratio engine 2 further includes sealing means 16 for providing a seal between cylinder head assembly 4 and crankcase assembly 6, wherein said sealing means 16 includes a sponge 18. Sealing means 16 is used primarily to contain engine oil inside of crankcase assembly 6.

Preferably sponge 18 is a closed cell sponge 20 for sealing crankcase assembly 6, where the closed sponge cells prevent passage of engine oil from the crankcase through the sponge.

Optionally sponge 18 has a sealed surface 22 for sealing crankcase 6. Optionally sponge 18 may have both a sealed surface 22 and closed cells 20, or only closed cells 20, or only a sealed surface 22.

Variable compression ratio engine 2 has an operational travel distance 24 for adjusting the compression ratio of the engine. Operational travel distance 24 is the maximum distance between large spacing 12 and small spacing 14. The operational travel distance 24 is preferably at least three millimeters, for providing the compression ratio range needed for engine performance and efficiency.

Variable compression ratio engine 2 preferably includes at least one sponge retaining rail 26 for retaining sponge 18 in place. Retaining rail or rails 26 are used to hold sponge 18 in place, and in particular when the crankcase pressure and atmospheric pressure are different. Retaining rails 26 may be formed in the cylinder head or crankcase castings, or removable parts as shown.

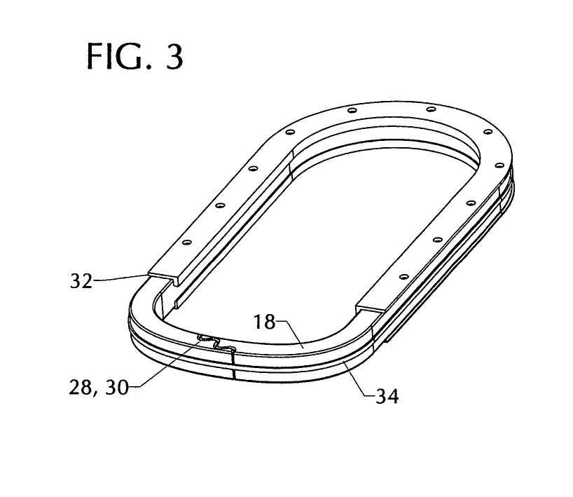

Referring now to FIG. 3, optionally sponge 18 may include an assembly seam 28 for simplifying assembly of sponge 18 on variable compression ratio engine 2. Optionally seam 28 may include an articulated surface 30 for improved sealing or holding the ends of the seal together. Optionally partially open retaining rails 32 may be used to simplify replacement of sponge 18 as may be needed from time to time. A retaining band 34 may optionally be used to retain sponge 18 in place.

1. A variable compression ratio engine 2 having a cylinder head assembly 4, a crankcase assembly 6, and a variable compression ratio 8,
cylinder head assembly 4 being movable relative to crankcase assembly 6 for adjusting the compression ratio of variable compression ratio engine 2, and
sealing means 16 for providing a seal between cylinder head assembly 4 and crankcase assembly 6,
wherein said sealing means 16 includes a sponge 18.

2. The variable compression ratio engine of claim 1 wherein said sponge 18 has closed sponge cells 20 for sealing crankcase assembly 6.

3. The variable compression ratio engine of claim 1 wherein said sponge 18 has a sealed surface 22 for sealing crankcase 6.

4. The variable compression ratio engine of claim 1 wherein cylinder head assembly 4 has an operational travel distance 24 for adjusting the compression ratio of variable compression ratio engine 2,
said operational travel distance 24 being at least three millimeters.

5. The variable compression ratio engine of claim 1 further including at least one sponge retaining rail 26 for retaining sponge 18 in place.

6. The variable compression ratio engine of claim 1 wherein sponge 18 further includes an assembly seam 28 for simplifying assembly of sponge 18 on variable compression ratio engine 2.

7. The variable compression ratio engine of claim 6 wherein seam 28 further includes an articulated surface 30 for joining seam 28.
